(19) United States
(12) Patent Application Publication
(10) Pub. No.: US 2026/0369201 A1
(43) Pub. Date: Nov. 19, 2026

(54) VOLTAGE SETTING METHOD OF DISPLAY DEVICE AND VOLTAGE SETTING DEVICE

(71) Applicant: Samsung Display Co., Ltd., Yongin-si (KR)

(72) Inventor: Si Beak PYO, Yongin-si (KR)

(73) Assignee: Samsung Display Co., Ltd., Yongin-si (KR)

(21) Appl. No.: 19/388,002

(22) Filed: Nov. 13, 2025

(30) Foreign Application Priority Data
May 16, 2025 (KR) 10-2025-0063916

(51) Int. Cl. G09G 3/20; G09G 3/3233

(52) U.S. Cl. CPC G09G 3/2007; G09G 3/3233; G09G 2300/0819; G09G 2300/0842; G09G 2300/0861; G09G 2310/0286; G09G 2310/06; G09G 2310/08; G09G 2320/0242; G09G 2320/0252; G09G 2320/0666; G09G 2320/0686; G09G 2320/0693; G09G 2360/144

(57) ABSTRACT

A voltage setting method includes for a plurality of luminances, setting first difference values between a first anode initialization voltage for a first color and a first power supply voltage; for some luminances of the plurality of luminances, setting second difference values between a second anode initialization voltage for a second color and the first power supply voltage; for the some luminances, setting offset values that are differences between the second difference values and the first difference values; based on the offset values for the some luminances, setting remaining offset values for remaining luminances; and for the remaining luminances, setting remaining difference values for the second color, based on the remaining offset values and the first difference values.

This application claims priority to Korean Patent Application No. 10-2025-0063916, filed on May 16, 2025, and all the benefits accruing therefrom under 35 U.S.C. § 119, the contents of which in their entirety are herein incorporated by reference.

### BACKGROUND

Some example embodiments relate to a voltage setting method of a display device and/or to a voltage setting device.

With the development of information technology, the importance of display devices as a connection medium between users and information has been increasing. In response to this, the use of display devices such as one or more of liquid crystal display devices, organic light emitting display devices, and the like is increasing.

To reduce manufacturing costs, multiple display devices can be formed simultaneously on a large area mother glass, and these display devices can be separated into individual display devices by scribing.

However, these individual display devices may contain elements with different driving characteristics, for example, due to their location on the mother glass, or for other reasons. Accordingly, if a voltage setting of the same magnitude is applied to all of the display devices, all of the display devices may not emit at a luminance corresponding to the grayscale.

### SUMMARY

Some example embodiments may provide a voltage setting method and/or a voltage setting device for a display device capable of displaying an image with a targeted luminance and color coordinates.

A voltage setting method of a display device according to some example embodiments includes: for a plurality of luminances, setting first difference values between a first anode initialization voltage for a first color and a first power supply voltage; for some luminances of the plurality of first luminances, setting second difference values between a second anode initialization voltage for a second color and the first power supply voltage; for the some luminances, setting offset values that are difference between the second difference values and the first difference values; based on the offset values for the some luminances, setting remaining offset values for remaining maximum luminances; and for the remaining luminances, setting remaining difference values for the second color, based on the remaining offset values and the first difference values.

The setting the first difference values may include: for a first luminances, setting a 1-1-th difference value between the first anode initialization voltage and the first power supply voltage; for a second luminances, setting a 1-2-th difference value between the first anode initialization voltage and the first power supply voltage; and for third luminance between the first and the second, interpolating the 1-1-th difference value and the 1-2-th difference value to set 1-3-th difference values between the first anode initialization voltage and the first power supply voltage.

In the setting the 1-1-th difference value, for the first one, the 1-1-th difference value may be set based on a maximum value among difference values that set a luminance of a black image of the display device being lower than a reference luminance as.

In the setting the 1-2-th difference value, for the second one, the 1-1-th difference value may be set based on a maximum value among difference values that set the luminance of the black image of the display device to be lower than the reference luminance.

The setting the second difference values may include: for the first luminance, setting a 2-1-th difference value between the second anode initialization voltage and the first power supply voltage; and for the second luminance, setting a 2-2-th difference value between the second anode initialization voltage and the first power supply voltage.

The setting the 2-1-th difference value may include: for the first luminance, detecting a first color coordinate of a first image in which a first grayscale is continuously displayed by the display device; for the first luminance, detecting a second color coordinate of a second image in which the first grayscale and black grayscale are alternately displayed by the display device; and setting a difference value in a case that a difference between the first color coordinate and the second color coordinate is minimum as the 2-1-th difference value.

The setting the 2-2-th difference value may include: for the second luminance, detecting a third color coordinate of a third image in which the first grayscale is continuously displayed by the display device; for the second luminance, wherein detecting a fourth color coordinate of a fourth image in which the first grayscale and the black grayscale are alternately displayed by the display device; and setting the 2-2-th difference value based on a difference value in a case that a difference between the third color coordinate and the fourth color coordinate is minimum.

The setting the offset values may include: for the first luminance, setting a first offset value that is a difference between the 2-1-th difference value and the 1-1-th difference value; and for the second luminance, setting a second offset value that is a difference between the 2-2-th difference value and the 1-2-th difference value.

The setting the remaining offset values may include: for the third luminances, interpolating the first offset value and the second offset value to set the third offset values.

The setting the remaining difference values may include: for the third luminances, setting the 2-3-th difference values between the second anode initialization voltage and the first power supply voltage by adding the third offset values to the 1-3-th difference values.

A voltage setting device according to some example embodiments includes: a test control unit configured to provide test voltages to a display device to enable the display device to display an image; and an optical system configured to measure luminance of and color coordinates of the image, wherein the test control unit is configured to, set first difference values between a first anode initialization voltage for a first color and a first power supply voltage for a plurality of luminances,, to set second difference values between a second anode initialization voltage for a second color and the first power supply voltage for some luminances of the plurality of luminances, to set offset values that are difference between the second difference values and the first difference values for the some luminances, based on the offset values for the some luminances, to set remaining offset values for remaining luminances, and to set remaining difference values for the second color, based on the remaining offset values and the first difference values for the remaining luminances.

In setting the first difference values, the test control unit may be configured to, set a 1-1-th difference value between the first anode initialization voltage and the first power supply voltage for a first luminance, may set a 1-2-th difference value between the first anode initialization voltage and the first power supply voltage for a second luminance, and may interpolate the 1-1-th difference value and the 1-2-th difference value to set 1-3-th difference values between the first anode initialization voltage and the first power supply voltage for third luminances between the first luminance and the second luminance.

When the test control unit sets the 1-1-th difference value, the test control unit, for the first maximum luminance, may set a maximum value among difference values that set a luminance of a black image of the display device to be lower than a reference luminance as the 1-1-th difference value.

In setting the 1-2-th difference value, the test control unit, may set a maximum value among difference values that set the luminance of the black image of the display device to be lower than the reference luminance as the 1-2-th difference value for the second maximum luminance.

In setting the second difference values, the test control unit, may set a 2-1-th difference value between the second anode initialization voltage and the first power supply voltage for the first luminance,, and, may set a 2-2-th difference value between the second anode initialization voltage and the first power supply voltage for the second luminance.

In setting the 2-1-th difference value, the test control unit, may detect a first color coordinate of a first image in which a first grayscale is continuously displayed by the display device for the first luminance, may detect a second color coordinate of a second image in which the first grayscale and black grayscale are alternately displayed by the display device for the first luminance, and may set a difference value in a case that difference between the first color coordinate and the second color coordinate is minimum as the 2-1-th difference value.

In setting the 2-2-th difference value, the test control unit, may detect a third color coordinate of a third image in which the first grayscale is continuously displayed by the display device for the second luminance, may detect a fourth color coordinate of a fourth image in which the first grayscale and the black grayscale are alternately displayed by the display device for the second luminance, and may set a difference value in a case that a difference between the third color coordinate and the fourth color coordinate is minimum as the 2-2-th difference value.

In setting the offset values, the test control unit, may set a first offset value that is a difference between the 2-1-th difference value and the 1-1-th difference value for the first luminance,, and may set a second offset value that is a difference between the 2-2-th difference value and the 1-2-th difference value for the second luminance.

In setting the remaining offset values, the test control unit may interpolate the first offset value and the second offset value to set the third offset values for the third luminances.

In setting the remaining difference values, the test control unit, may set the 2-3-th difference values between the second anode initialization voltage and the first power supply voltage by adding the third offset values to the 1-3-th difference values for the third luminances.

### BRIEF DESCRIPTION OF THE DRAWINGS

The above and other features will become more apparent by describing in further detail some example embodiments thereof with reference to the accompanying drawings, in which:

FIG. 1 is a drawing for illustrating a display device according to some example embodiments.

FIG. 2 is a drawing for illustrating a pixel according to some example embodiments.

FIGS. 3 and 4 are drawings for illustrating a display frequency change according to some example embodiments.

FIG. 5 is a drawing for illustrating an address scan period, according to some example embodiments.

FIG. 6 is a drawing for illustrating a self scan period according to some example embodiments.

FIG. 7 is a drawing for illustrating a voltage setting device according to some example embodiments.

FIGS. 8 to 15 are drawings for illustrating a voltage setting method of a display device according to some example embodiments.

FIGS. 16 to 18 are drawings for illustrating a voltage setting method of a display device according to some example embodiments.

FIG. 19 is a block diagram of an electronic device according to some example embodiments.

FIGS. 20 through 22 are schematic diagrams of electronic devices according to various example embodiments.

### DETAILED DESCRIPTION

Hereinafter, with reference to the accompanying drawings, various embodiments will be described in detail to facilitate practice by one having ordinary skill in the art to which the invention belongs. Example embodiments may be implemented in many different forms and is not limited to the embodiments described herein.

In order to clearly illustrate the invention, parts not pertinent to the description have been omitted, and identical or similar components are designated by the same reference numerals throughout the specification. Accordingly, the aforementioned reference numerals may be used in other drawings.

Further, the size and thickness of each configuration shown in the drawings is arbitrarily indicated for ease of illustration and the invention is not necessarily limited to that shown. Thicknesses may be exaggerated in the drawings to clearly represent different layers and regions.

Also, when the term “identical” is used in the description, it is intended to mean “substantially identical,” i.e., identical to the extent that a person of ordinary skill in the art would be satisfied that they are identical. Other expressions may also omit “substantially”.

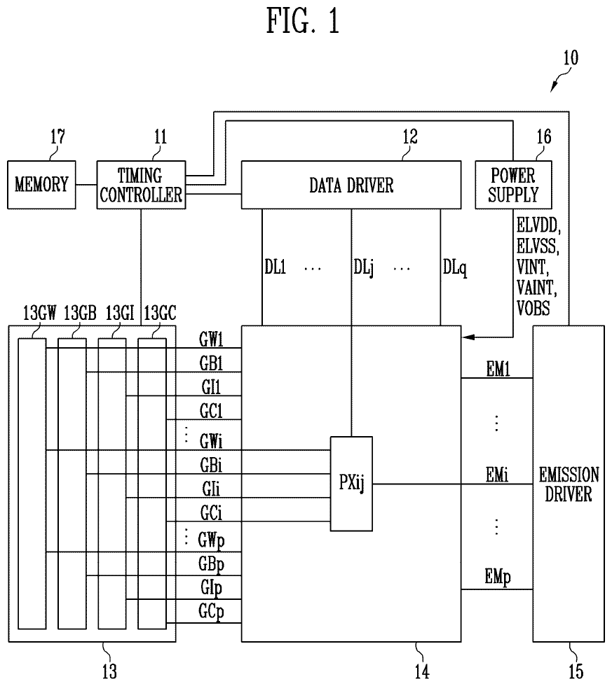

FIG. 1 is a drawing to illustrate a display device according to some example embodiments.

Referring to FIG. 1, a display device 10 according to some example embodiments may include a timing controller 11, a data driver 12, a scan driver 13, a pixel unit 14, an emission driver 15, a power supply 16, and a memory 17.

The timing controller 11 may receive grayscales for the input image (or, an input frame of a video). The grayscales may include a first color grayscale, a second color grayscale, and a third color grayscale. The first color grayscale may be or may correspond to a grayscale for representing a first color, the second color grayscale may be or may correspond to a grayscale for representing a second color, and the third color grayscale may be or may correspond to a grayscale for representing a third color.

Further, the timing controller 11 may receive control signals for the image. These control signals may include a horizontal synchronization signal (Hsync), a vertical synchronization signal (Vsync), and a data enable signal. The vertical synchronization signal may include a plurality of pulses, each of which indicates an end of a previous vertical frame period and a beginning of a current vertical frame period, based on when the pulse occurs. The interval between adjacent pulses of the vertical synchronization signal may correspond to one frame period. The horizontal synchronization signal may include a plurality of pulses, each of which may indicate an end of a previous horizontal period and a beginning of a new horizontal period based on when the pulses occur. The interval between adjacent pulses of the horizontal synchronization signal may correspond to one horizontal period. A data enable signal may have an enable level for certain horizontal periods and a disable level for the rest of the period. When the data enable signal is at the enable level, the data enable signal being at the enable level may indicate that color grayscales are supplied in those horizontal periods.

The timing controller 11 may provide grayscales rendered and/or calibrated to meet the specifications of the display device 10 to the data driver 12. Alternatively or additionally, the timing controller 11 may provide one or more of clock signals, scan start signals, and the like to the scan driver 13. The timing controller 11 may provide one or more of a clock signal, an emission stop signal, and the like to the emission driver 15.

The data driver 12 may generate data voltages to be provided to the data lines DL1, . . . , DLj, . . . , DLq by utilizing the grayscales and control signals received from the timing controller 11. The data driver 12 may sample the grayscales using a clock signal, and may apply the data voltages corresponding to the grayscales to the data lines in a unit of a pixel row. Here, q may be an integer greater than 2, and j may be an integer greater than 1 and less than q.

The magnitudes of the data voltages may vary depending on the corresponding grayscale. The data voltages may include a black data voltage. The black data voltage may be or may correspond to a data voltage that is written to a pixel when the pixel displays a black image. For example, the black data voltage may correspond to a minimum grayscale (e.g., zero grayscale).

The magnitude of the data voltages may vary depending on a luminance, such as on a maximum luminance of the display device 10. The maximum luminance may be or may correspond to a luminance of light emitted by the pixels set to a maximum grayscale (e.g., a grayscale of 255 in the case of where grayscales are represented by 8 bits). For example, the maximum luminance may be or may correspond to a luminance of white light generated by emitting the pixels of the pixel unit 14 to correspond to a white grayscale. In some example embodiments, the unit of the luminance may be Nits, or one candela per square meter. The maximum luminance may be named as or may be referred to as a Display Brightness Value. Such a maximum luminance may be set manually, for example, by a user's operation of the display device 10. Alternatively or additionally, such a maximum luminance may be set automatically by an algorithm associated with an illumination sensor or the like. For example, the maximum value of the maximum luminance may be 3000 nits, and the minimum value may be 10 nits. The maximum and minimum values of the maximum luminance may vary depending on a product which includes the display device 10. For the same grayscale, different maximum luminance will result in different data voltages, and thus there may be different luminance of the pixels.

The scan driver 13 may include first to fourth scan drivers 13GW, 13GB, 13GI, 13GC. The first scan driver 13GW may provide first scan signals to the first scan lines GW1, . . . , GWi, . . . , GWp. Here, p may be an integer greater than 2, and i may be an integer greater than 1 and less than p. Here, p may be less than, greater than, or equal to q. The second scan driver 13GB may provide the second scan signals to the second scan lines GB1, . . . , GBi, . . . , GBp. The third scan driver 13GI may provide the third scan signals to the third scan lines GI1, . . . , GIi, . . . , GIp. The fourth scan driver 13GC may provide the fourth scan signals to the fourth scan lines GC1, . . . , GCi, . . . , GCp.

For example, the first scan driver 13GW may generate first scan signals to be provided to the first scan lines GW1 to GWp by receiving at least one scan clock signal and a scan start signal from the timing controller 11. The first scan driver part 13GW may provide the first scan signals having a turn-on level of pulses to the first scan lines GW1 to GWp sequentially. For example, the first scan driver 13GW may be configured in the form of a shift register, and may generate the first scan signals by sequentially delivering the scan start signals in the form of pulses of the turn-on level to the next scan stage under control of the scan clock signal.

Each of the second scan driver 13GB, the third scan driver 13GI, and the fourth scan driver 13GC may be configured similarly to the first scan driver 13GW, and therefore, redundant description is omitted. According to some example embodiments, at least some of the first to fourth scan drivers 13GW, 13GB, 13GI, and 13GC may be integrated. For example, two or more scan drivers may be integrated if the polarity and width of the pulses are the same. For example, referring now to FIG. 5, the third scan driver 13GI and the fourth scan driver 13GC may be integrated because the polarity and width of the pulses of the turn-on level applied at time t2a to the third scan line GIi and the pulses of the turn-on level applied at time t3a to the fourth scan line GCi are the same.

The emission driver 15 may generate emission signals to be provided to the emission lines EM1, . . . , EMi, . . . , EMp by receiving at least one emission clock signal and an emission stop signal from the timing controller 11. The emission driver 15 may provide the emission signals having pulses of the turn-off level sequentially to the emission lines EM1 through EMp. For example, the emission driver 15 may be configured in the form of a shift register, and may generate the emission signals by sequentially delivering the emission stop signals in the form of pulses of the turn-off level to the next emission stage under control of the emission clock signal.

In FIG. 1, there are shown to be p first scan lines GW1 to GWp, p second scan lines GB1 to GBp, p third scan lines GI1 to GIp, p fourth scan lines GC1 to GCp, and p emission lines EM1 to EMp are shown as p each. However, example embodiments are not limited thereto. For example, in some example embodiments, at least one of the second scan lines GB1 to GBp, the third scan lines GI1 to GIp, the fourth scan lines GC1 to GCp, and the emission lines EM1 to EMp may includes p/2 or fewer. For example, two neighboring rows of pixels may share one second scan line. Alternatively or additionally, two neighboring rows of pixels may share one third scan line, fourth scan line, or emission line. The same pixel row indicates pixels connected to the same first scan line.

The pixel unit 14 includes pixels PXij. Each pixel PXij may be connected to a corresponding data line DLj, a set of scan lines GWi, GBi, GIi, GCi, and an emission line EMi. Each pixel PXij may include a light emitting element that emits based on the received data voltage. In some example embodiments, the light emitting element may be or may include or be based on an organic light emitting diode (OLED); however, example embodiments are not limited thereto.

The pixel unit 14 may include first pixels emitting light of the first color, second pixels emitting light of the second color, and third pixels emitting light of the third color. The first color, the second color, and the third color may be different colors. For example, the first color may be any one of red, green, and blue, the second color may be any one of red, green, and blue that is not the first color, and the third color may be any remaining color that is not the first and second colors among red, green, and blue. Alternatively or additionally, one or more of magenta, cyan, and yellow may be used in place of one or more of red, green, and blue as the first through third colors.

The pixel unit 14 may be arranged in various shapes, such as one or more of diamond PENTILE™, RGB-Stripe, S-stripe, Real RGB, normal PENTILE™, etc.

The power supply 16 may provide voltages common to the pixels of the pixel unit 14. For example, the power supply 16 may provide a first power supply voltage ELVSS, a second power supply voltage ELVDD, an initialization voltage VINT, an anode initialization voltage VAINT, and a bias voltage VOBS. For example, the power supply 16 may be or may include, or be included in, a power management integrated circuit (PMIC). For example, the power supply 16 may include a plurality of DC-DC converters, such as but not limited to one or more of buck converters, boost converters, buck-boost converters, cuck converters, or converters including a transformer.

The memory 17 may store voltage values set for at least some of the plurality of voltages ELVSS, ELVDD, VINT, VAINT, VOBS, . . . . A method of setting the voltage values stored in the memory 17 will be described in more detail with reference to FIGS. 7 to 18. For example, the timing controller 11 may adjust the magnitude of the voltages ELVDD, ELVSS, VINT, VAINT, VOBS, . . . provided from the power supply 16 and the data voltages provided from the data driver 12 by referring to the voltage values in the memory.

According to some example embodiments, the timing controller 11 and the data driver 12 may be configured as one integrated circuit. According to some example embodiments, the timing controller 11, the data driver 12, and the power supply 16 may be configured as one integrated circuit. According to some example embodiments, at least some of the timing controller 11, the data driver 12, the power supply 16, the scan driver 13, the emission driver 15, and the memory 17 may be configured as one integrated circuit. Configuring each of these components integrally or separately may be determined in a variety of ways, for example, in ways depending on the product that includes the data driver 10.

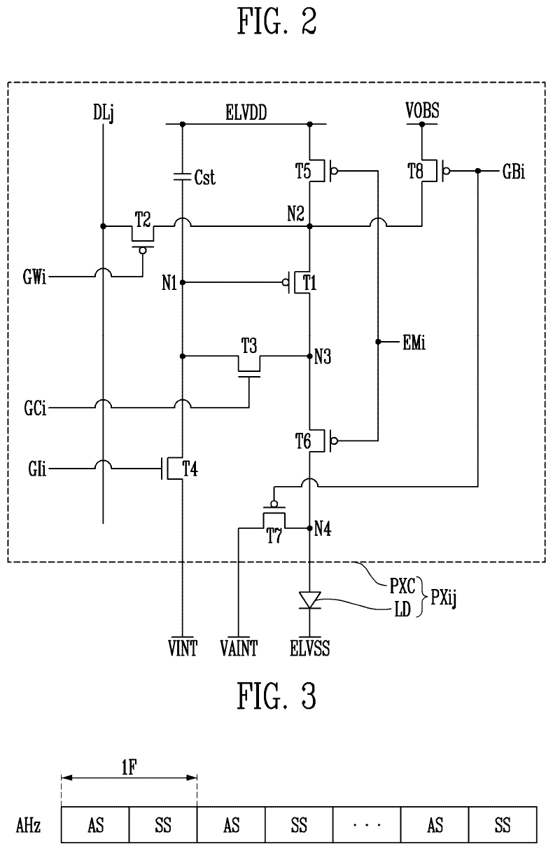

FIG. 2 is a drawing to illustrate a pixel according to some example embodiments.

Referring to FIG. 2, a pixel PXij may include a pixel circuit PXC and a light emitting element LD. The pixel circuit PXC includes transistors T1, T2, T3, T4, T5, T6, T7, T8, and a storage capacitor Cst.

The pixel PXij may be located in the i-th pixel row, and may be located in the j-th pixel column. The pixel PXij may be or may correspond to a first pixel for representing the first color. The second pixel for expressing the second color and the third pixel for expressing the third color may be configured the same as the first pixel, so that redundant description is omitted, although example embodiments are not limited thereto.

The pixel PXij is described as an eight-transistor pixel; example embodiments are not limited thereto. Additionally, physical and/or electrical properties of each P-type transistor may be the same as each other; alternatively, at least one P-type transistor may have a different physical and/or electrical properties than at least one other of the P-type transistors. Alternatively or additionally, physical and/or electrical properties of each N-type transistor may be the same as each other; alternatively, at least one N-type transistor may have a different physical and/or electrical properties than at least one other of the N-type transistors. Physical properties may include properties such as one or more of a gate width, a gate length, and a dielectric thickness; electrical properties may include one or more of a threshold voltage or a saturation current; example embodiments are not limited thereto.

All of, or at least one of. the P-type transistors, e.g., transistors T1, T2, T5, T6, T7, and T8 may be or may include or be based on polysilicon semiconductor transistors. In the polysilicon semiconductor transistor, a channel of an active layer may include a polysilicon semiconductor. For example, the polysilicon semiconductor transistor may be or include a low temperature poly-silicon (LTPS) thin film transistor. Polysilicon semiconductor transistors have high electron mobility, and thus may have fast driving characteristics.

All of, or at least one of, the N-type transistors, e.g., transistors T3 and T4, may be or may include or be based on oxide semiconductor transistors. In the oxide semiconductor transistor, a channel of an active layer may include an oxide semiconductor. For example, the oxide transistor may be a low temperature polycrystalline oxide (LTPO) thin film transistor. Oxide semiconductor transistors have lower charge mobility compared to polysilicon semiconductor transistors. Accordingly, the oxide semiconductor transistors may have a smaller amount of leakage current in the turn-off state compared to polysilicon semiconductor transistors.

The first transistor T1 may have a gate electrode connected to a first node N1, a first electrode connected to a second node N2, and a second electrode connected to a third node N3. The first transistor T1 may be a driving transistor. The first transistor T1 may be a P-type transistor.

The second transistor T2 may have a gate electrode connected to the first scan line GWi, a first electrode connected to the data line DLj, and a second electrode connected to the second node N2. The second transistor T2 may be a switching transistor. The second transistor T2 may be a P-type transistor.

The first scan driver 13GW may provide a first scan signal of the turn-on level that determines when the pixel PXij receives the data voltage. For example, in response to receiving the first scan signal of the turn-on level, the second transistor T2 may be turned on, and the second transistor T2 may apply the data voltage applied on the data line DLj to the second node N2.

The third transistor T3 may have a gate electrode connected to the fourth scan line GCi, a first electrode connected to the first node N1, and a second electrode connected to the third node N3. The third transistor T3 may be a diode-connected transistor. The third transistor T3 may be an N-type transistor.

The fourth transistor T4 may have a gate electrode connected to the third scan line GIi, a first electrode connected to the first node N1, and a second electrode receiving an initialization voltage VINT. The fourth transistor T4 may be a gate initialization transistor. The fourth transistor T4 may be an N-type transistor.

The fifth transistor T5 may have a gate electrode connected to the emission line EMi, a first electrode receiving a second power supply voltage ELVDD, and a second electrode connected to the second node N2. The fifth transistor T5 may be a first emission control transistor. The fifth transistor T5 may be a P-type transistor.

The sixth transistor T6 may have a gate electrode connected to the emission line EMi, a first electrode connected to the third node N3, and a second electrode connected to the fourth node N4. The sixth transistor T6 may be a second emission control transistor. The sixth transistor T6 may be a P-type transistor.

The seventh transistor T7 may have a gate electrode connected to the second scan line GBi, a first electrode receiving an anode initialization voltage VAINT, and a second electrode connected to the fourth node N4. The seventh transistor T7 may be an anode initialization transistor. The seventh transistor T7 may be a P-type transistor. A magnitude of the anode initialization voltage VAINT (e.g., an absolute value of the anode initialization value VAINT) may be different from a magnitude of the initialization voltage VINT (e.g., an absolute value of the initialization voltage VINT).

The anode initialization voltage VAINT may be set differently, and in some example embodiments may be set depending on the type of light emitting element LD. The emission start time differs depending on the type of light emitting element LD, and the difference in the emission start time may cause a color dragging phenomenon. For example, the magnitudes of the anode initialization voltage VAINT for the light emitting element LD of the first color, the anode initialization voltage VAINT for the light emitting element LD of the second color, and the anode initialization voltage VAINT for the light emitting element LD of the third color may be set differently. In some example embodiments, the anode initialization voltages VAINT for two colors of light emitting elements LD may be set to be the same, and the anode initialization voltage VAINT for the remaining one color of light emitting elements LD may be set to be different. In some example embodiments, the anode initialization voltages VAINT for all light emitting elements LD may be set to be the same. By doing so, the difference in the emission timing of the light emitting elements LD for each color can be adjusted to prevent or reduce color dragging.

The initialization voltage VINT may be set common to the pixels of the first, second, and third colors. For example, the initialization voltage VINT may be applied at the same voltage level to the gate electrodes of the driving transistors included in the pixels of all colors.

The second scan driver 13GB may provide a second scan signal of the turn-on level that determines a timing for initializing the anode voltage of the light emitting element LD. For example, the seventh transistor T7 may be turned on in response to receiving the second scan signal of the turn-on level, and the anode initialization voltage VAINT may be applied to the anode of the light emitting element LD, such that the anode voltage of the light emitting element LD is initialized to the anode initialization voltage VAINT.

The eighth transistor T8 may have a gate electrode connected to the second scan line GBi, a first electrode receiving a bias voltage VOBS, and a second electrode connected to the second node N2. The eighth transistor T8 may be a bias transistor. The eighth transistor T8 may be a P-type transistor.

The storage capacitor Cst may have a first electrode receiving a second power supply voltage ELVDD, and a second electrode may be connected to the first node N1. The storage capacitor Cst may be or may include a metal-insulator-metal (MIM) capacitor; however, example embodiments are not limited thereto.

The light emitting element LD may be connected to the fourth node N4, and the cathode may receive the first power supply voltage ELVSS. The light emitting element LD may emit in one of a first color, a second color, and a third color. The light emitting element LD may be a light emitting diode; example embodiments are not limited thereto. The light emitting element LD may include one or more of an organic light emitting diode, an inorganic light emitting diode, a quantum dot/well light emitting diode, and the like. Different pixels PXij may include the same type, or different types, of light emitting elements LD. In some example embodiments, each pixel is equipped with only one light emitting element (LD), but example embodiments are not limited thereto. For example, in some example embodiments, each pixel or at least some pixels may be equipped with a plurality of light emitting elements. In this case, the plurality of light emitting elements may be connected in series, parallel, series-parallel, or the like.

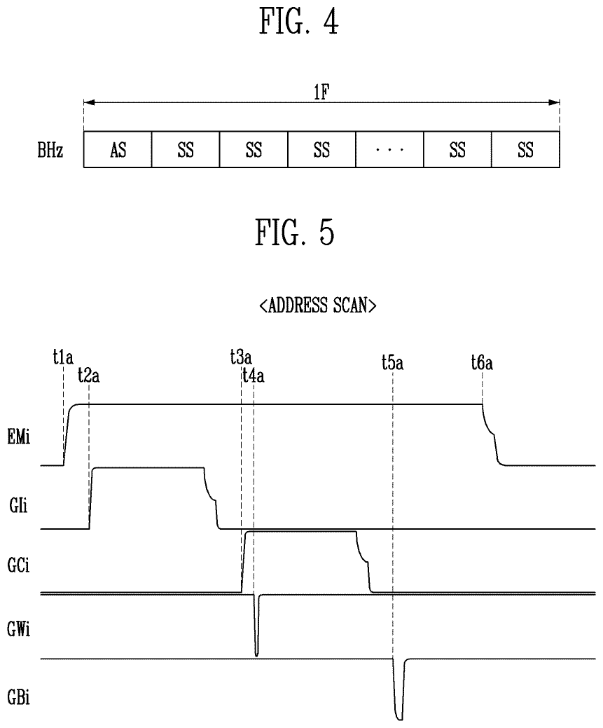

FIGS. 3 and 4 are drawings to illustrate changing the display frequency according to some example embodiments.

The display device 10 may support a variable refresh rate (VRR). The refresh rate is or corresponds to the frequency at which a data voltage is written to the pixel PXij, which may also be referred to as a scan rate of the screen and/or a play rate of the screen, and may represent the number of image frames played during one second.

For example, the pixel unit 14 may display an image at a first frequency AHz in a first mode (see FIG. 3), and may display an image at a second frequency BHz that is smaller than the first frequency AHz in a second mode (see FIG. 4).

For example, in the first mode, each frame period 1F may include, for each pixel PXij, one address scan period AS and one self scan period SS. For example, in the second mode, each frame period 1F may include, for each pixel PXij, one address scan period AS and a plurality of self scan periods SS. As the second frequency BHz is smaller, the number of self scan periods SS included in one frame period 1F may increase. In another example, in the third mode, each frame period 1F may include, for each pixel PXij, only one address scan period AS and no self scan periods SS.

The address scan period AS is or corresponds to the period during which the data voltage is written to the pixel PXij. The address scan period AS may also be named as a data programming period, which receives data voltage from the data line DLj.

The self scan period SS is or corresponds to a period during which no data voltage is written to the pixel PXij. During the emission period of the self scan period SS, the pixel PXij may emit using the data voltage written in the address scan period AS. The length of the self scan period SS may be the same as the length of the address scan period AS.

FIG. 5 is a drawing to illustrate an address scan period according to some example embodiments. In describing FIG. 5, reference is made to the pixel PXij of FIG. 2.

At a time point t1a, an emission signal of a turn-off level (e.g., a high level) is applied to the emission line EMi, such that the fifth transistor T5 and the sixth transistor T6 are turned off, and the pixel PXij is in a non-emitting state.

At time point t2a, a third scan signal of the turn-on level (high level) is applied to the third scan line GIi, thereby turning on the fourth transistor T4. Accordingly, an initialization voltage VINT is applied to the first node N1. The initialization voltage VINT may be a sufficiently low voltage to turn the first transistor T1 on-bias.

At time point t3a, the third transistor T3 is turned on by applying a fourth scan signal of the turn-on level (high level) to the fourth scan line GCi. Accordingly, the first transistor T1 is in a diode connection state in which the drain electrode and the gate electrode are connected.

At time point t4a, the second transistor T2 is turned on by applying a scan signal of the turn-on level (low level) to the first scan line GWi. Thus, a data voltage of the data line DLj may be applied to the first node N1 through the second transistor T2, the first transistor T1, and the third transistor T3 in the turn-on state. At this time, the voltage of the first node N1 may be or may correspond to a compensation voltage that is a data voltage minus a threshold voltage of the first transistor T1. The storage capacitor Cst may maintain a difference between the second power supply voltage ELVDD and the compensation voltage.

At a time point t5a, a scan signal of the turn-on level (e.g., a low level) is applied to the second scan line GBi, thereby turning on the seventh transistor T7 and the eighth transistor T8. As the seventh transistor T7 is turned on, an anode initialization voltage VAINT is applied to the anode of the light emitting element LD, and the light emitting element LD may be initialized with a charge amount corresponding to a voltage difference between the anode initialization voltage VAINT and the first power supply voltage ELVSS. Accordingly, a low grayscale expression of the light emitting element LD may be facilitated.

Further, as the eighth transistor T8 is turned on, the voltage of the second node N2 may be set to a bias voltage VOBS. Accordingly, since the bias voltage VOBS is applied to the source electrode of the first transistor T1, a hysteresis phenomenon may be prevented or reduced in likelihood of occurrence and/or in impact from occurrence, and an on-bias state may be ensured or be more likely to be ensured.

At time t6a, the fifth transistor T5 and the sixth transistor T6 may be turned on by applying an emission signal of the turn-on level (low level) to the emission line EMi. Thus, a path of a driving current flowing from the second power supply voltage ELVDD toward the first power supply voltage ELVSS via the fifth transistor T5, the first transistor T1, the sixth transistor T6, and the light emitting element LD is formed.

The amount of driving current may be adjusted according to the voltage maintained on, e.g., stored in, the storage capacitor Cst. The light emitting element LD emits light with a luminance corresponding to the amount of driving current. The light emitting element LD may emit until an emission signal of the turn-off level is applied to the emission line EMi.

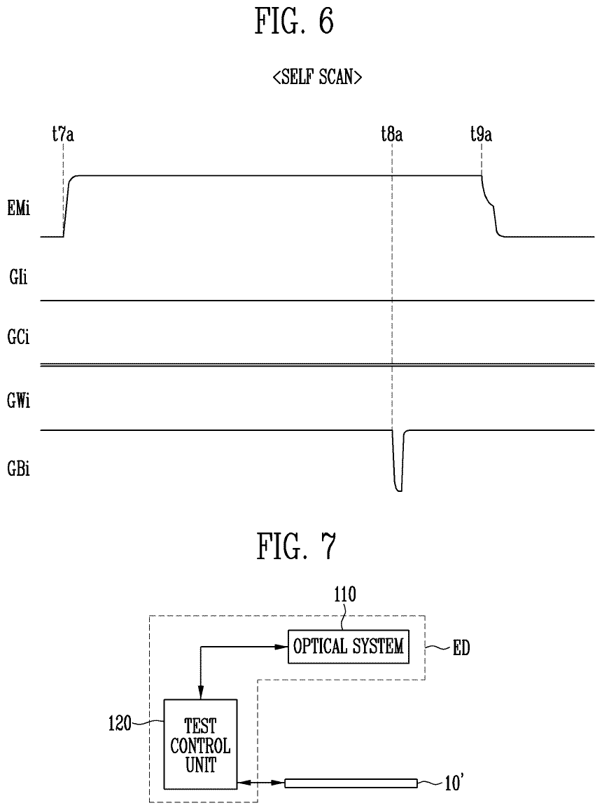

FIG. 6 is a drawing for illustrating a self scan period according to some example embodiments. In describing FIG. 6, reference is made to the pixel PXij of FIG. 2.

At time point t7a, as an emission signal of the turn-off level (e.g., the high level) is applied to the emission line EMi, the fifth transistor T5 and the sixth transistor T6 are turned off, and the pixel PXij is in a non-emitting state.

During a period t7a to t8a, the scan signals of the turn-off level are maintained in the first scan line GWi, the third scan line GIi, and the fourth scan line GCi. Thus, the voltage of the first node N1 does not fluctuate or is less likely to fluctuate.

At a time point t8a, a scan signal of the turn-on level (e.g. the low level) is applied to the second scan line GBi, thereby turning on the seventh transistor T7 and the eighth transistor T8. As the seventh transistor T7 is turned on, an anode initialization voltage VAINT is applied to the anode of the light emitting element LD, and the light emitting element LD may be initialized with a charge amount corresponding to a voltage difference between the anode initialization voltage VAINT and the first power supply voltage ELVSS. Accordingly, the low grayscale expression of the light emitting element LD may be facilitated.

Further, as the eighth transistor T8 is turned on, the voltage of the second node N2 may be set to a bias voltage VOBS. Accordingly, since the bias voltage VOBS is applied to the source electrode of the first transistor T1, a hysteresis phenomenon may be prevented or reduced in likelihood of occurrence and/or in impact from occurrence, and an on-bias state may be ensured or be more likely to be ensured.

At time t9a, the fifth transistor T5 and the sixth transistor T6 may be turned on by applying an emission signal of the turn-on level (low level) to the emission line EMi. Thus, a path of a driving current flowing from the second power supply voltage ELVDD toward the first power supply voltage ELVSS via the fifth transistor T5, the first transistor T1, the sixth transistor T6, and the light emitting element LD is formed.

Depending on the voltage maintained in the storage capacitor Cst, the amount of driving current may be adjusted. Since the voltage of the first node N1 written during the address scan period AS is maintained during the self scan period SS, the luminance of the pixel PXij in the self scan period SS may be the same as the luminance of the pixel PXij in the address scan period AS.

FIG. 7 is a drawing to illustrate a voltage setting device according to some example embodiments.

Referring to FIG. 7, a voltage setting device ED according to some example embodiments may include an optical system 110 and a test control unit 120. The optical system 110 may measure luminance and color coordinates of an image. For example, the optical system 110 may include a camera, a luminance meter, a colorimeter, a spectrometer, a spectrophotometer, or the like. The test control unit 120 may be or may include (or be included in) a computing device. For example, the computing device may include a recording medium and a processor. The recording medium and the processor may be included on the same physical device, but may also be included on physically different devices, such as by utilizing a cloud technology.

A recording medium includes any type of recording device that can store data and/or programs that can be read by a processor. The stored data and/or programs may be non-transitory. Examples of processor-readable storage media include ROMs, RAM, CD-ROMs, magnetic tapes, floppy disks, optical data storage devices, hard disks, external hard disks, SSDs, USB storage devices, DVDs, Blu-ray disks, and the like. The processor-readable storage medium may also or alternatively be a combination of multiple devices and may be distributed across a networked computer system. Such a recording medium may be or may include a non-transitory computer readable medium. A non-transitory recording medium is or includes a medium that stores data or programs on a semi-permanent basis and is readable by a processor.

The test control unit 120 may provide test voltages to the display device 10′ to enable the display device 10′ to display an image.

The display device 10′ may refer to a single display device, or may refer to a plurality of display devices. The display device 10′ may refer to one of a plurality of display devices formed on a large-area mother glass. For example, the voltage setting process may be performed prior to scribing the mother glass. In some example embodiments, the display device 10′ may be or may correspond to the display device 10 described above with respect to FIGS. 1-6; example embodiments are not limited thereto.

The optical system 110 may perform one or more of acquiring an image displayed by the display device 10′ based on the test voltages, measuring the luminance of the image, or measuring the color coordinates of the image. The optical system 110 may provide one or more of the image, the luminance of the image, the color coordinates of the image, and the like to the test control unit 120.

The test control unit 120 may set the test voltages determined to be suitable for the display device 10′ to voltage values of the display device 10′. The set voltage values may be stored in the memory 17 of the display device 10′ (see FIG. 1).

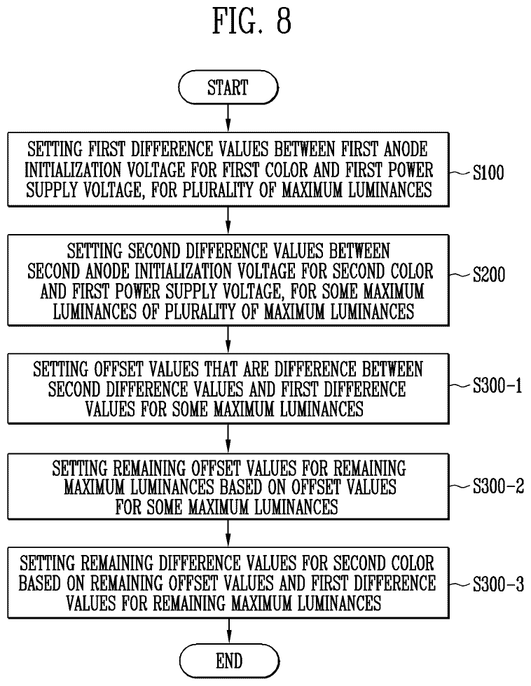

FIGS. 8 through 15 are drawings to illustrate a voltage setting method for a display device according to some example embodiments.

The test control unit 120 may set a first difference values VAR_R between the first anode initialization voltage for the first color and the first power supply voltage, for a plurality of maximum luminances (S100).

As described above, it may be assumed that, for example, a maximum value of the plurality of maximum luminances is 3000 Nits and a minimum value is 10 Nits; however, example embodiments are not limited thereto.

Here, the first color may be the color that contributes the most to the luminance of the display device 10′ among the first to third colors. For example, the first color may be red or green. A smaller difference value between the anode initialization voltage VAINT and the first power supply voltage ELVSS may have the advantage of facilitating low grayscale representation. For example, a smaller difference value between the anode initialization voltage VAINT and the first power supply voltage ELVSS can reduce black excitation. Since the first color contributes more to luminance than the other colors, the first difference values VAR_R may be set such that no black artifacts occur.

The test control unit 120 may set a second difference values VAR_B between the second anode initialization voltage for the second color and the first power supply voltage ELVSS, for some maximum luminances of the plurality of maximum luminances (S200).

In some example embodiments, the second color may be or may correspond to the color that contributes the most to the speed of the response of the display device 10′ among the first to third colors. For example, if the screen is scrolled quickly, an image with an undesirable color may be displayed. For example, the second color may be blue. A larger value of the difference value between the anode initialization voltage VAINT and the first power supply voltage ELVSS may have the advantage of increasing the response speed of the pixel PXij and reducing the temperature sensitivity. Since the second color contributes more to the response speed than the other colors, the second difference values VAR_B should be set to increase the response speed.

However, finding appropriate second difference values VAR_B for all of the maximum luminances in operation S200 may be excessively time consuming. Therefore, operation S200 may be performed for only some maximum luminances of the plurality of maximum luminances. The some maximum luminances may include a minimum value and a maximum value of the plurality of maximum luminances. For example, the some maximum luminances may be 10 Nits, 100 Nits, and 3000 Nits.

The test control unit 120 may set offset values OFFSET that are difference between the second difference values VAR_B and the first difference values VAR_R for the some maximum luminances (S300-1). For example, the test control unit 120 may set the offset values OFFSET by subtracting the first difference values VAR_R from the second difference values VAR_B for the some maximum luminances.

The test control unit 120 may set remaining offset values OFFSET for the remaining maximum luminances based on the offset values OFFSET for the some maximum luminances (S300-2). The remaining maximum luminances may be the maximum luminances among the plurality of maximum luminances except the some maximum luminances. For example, the remaining maximum luminances may be 15 Nits, 30 Nits, 60 Nits, 200 Nits, 300 Nits, 650 Nits, 1200 Nits, 1600 Nits, or 1600 Nits. For example, the test control unit 120 may interpolate the offset values OFFSET for the some maximum luminances to set the remaining offset values OFFSET for the remaining maximum luminances.

The test control unit 120 may set a remaining difference values VAR_B for the second color based on the remaining offset values OFFSET and the first difference values VAR_R for the remaining maximum luminances (S300-3). For example, the test control unit 120 may set the remaining difference values VAR_B for the second color by adding the remaining offset values OFFSET to the first difference values VAR_R for the remaining maximum luminances.

The display device 10′ with the voltage setting according to some example embodiments may reduce the black excitation for the first color and increase the response speed for the second color. Thus, the display device 10′ may display an image with a targeted luminance and color coordinates.

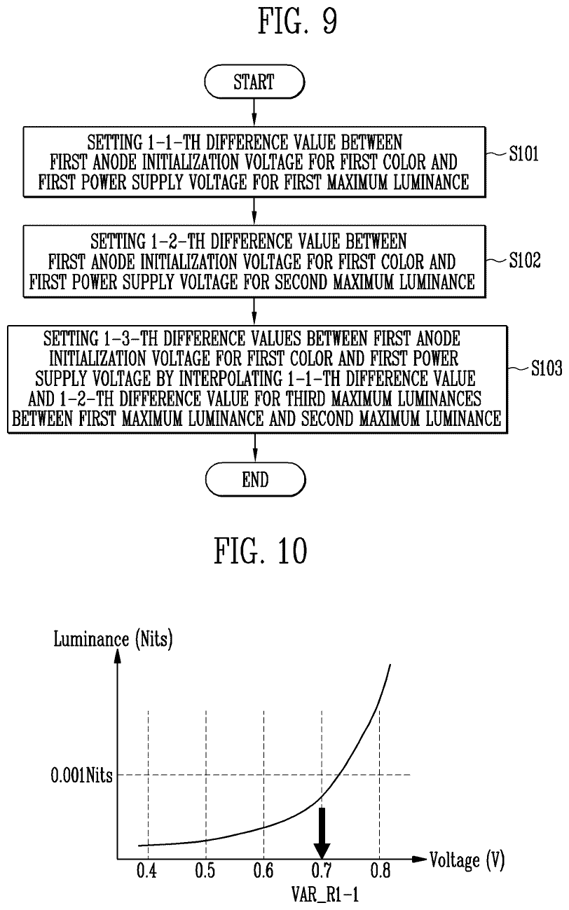

Referring to FIG. 9, operation S100 may include further operations S101, S102, and S103. The first difference values VAR_R may include a 1-1-th difference value VAR_R1−1, a 1-2-th difference value, and a 1-3-th difference value.

First, the test control unit 120 may set the 1-1-th difference value VAR_R1−1 between the first anode initialization voltage and the first power supply voltage ELVSS for the first maximum luminance (S101). For example, it may be assumed that the first maximum luminance is 10 Nits.

Referring to FIG. 10, a graph of a luminance according to a difference value between a first anode initialization voltage and a first power supply voltage ELVSS is shown when the display device 10′ displays a black image of a black grayscale. At this time, the difference value for the second color and the difference value for the third color may be set as the difference value of FIG. 10 plus a predetermined offset.

For the first maximum luminance, the test control unit 120 may set the maximum value among difference values that set the luminance of the black image of the display device 10′ to be lower than a reference luminance as the 1-1-th difference value VAR_R1−1. For example, the reference luminance may be 0.001 Nits. Referring to the graph illustrated in FIG. 10, the difference values that set the luminance of the black image to be lower than the reference luminance may be 0.4 volts, 0.5 volts, 0.6 volts, and 0.7 volts. The test control unit 120 may set the maximum value among these, 0.7 V, as the 1-1-th difference value VAR_R1−1. According to some example embodiments, the 1-1-th difference value VAR_R 1-1 may be set such that the response speed is as fast as possible without causing black excitation.

The test control unit 120 may set a 1-2-th difference value between the first anode initialization voltage and the first power supply voltage ELVSS for the second maximum luminance (S102). For example, it is assumed that the second maximum luminance is 100 Nits. At this time, the test control unit 120 may set the maximum value among the difference values that set the luminance of the black image of the display device 10′ to be lower than the reference luminance as the 1-2-th difference value for the second maximum luminance. The process of setting the 1-2-th difference value may be substantially the same as the process of setting the 1-1-th difference value VAR_R 1-1, and therefore will not be described in detail.

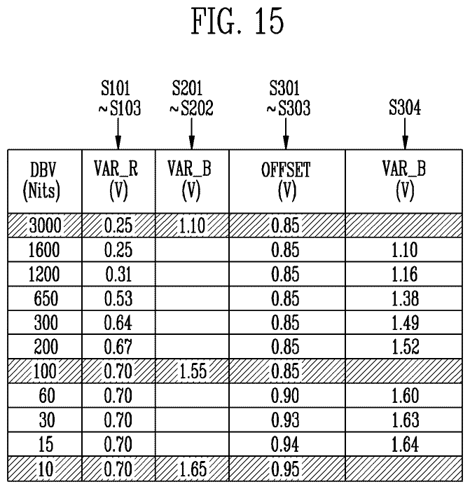

The test control unit 120 may set a 1-3-th difference values between the first anode initialization voltage and the first power supply voltage ELVSS by interpolating the 1-1-th difference value VAR_R 1 -1 and the 1-2-th difference value for third maximum luminances between the first maximum luminance and the second maximum luminance (S103). For example, the third maximum luminances may be 15 Nits, 30 Nits, and 60 Nits. In this case, the interpolation may be performed based on a magnitude of the first power supply voltage ELVSS corresponding to the third maximum luminances. However, referring to FIG. 15, a case is illustrated in which the 1-1-th difference value VAR_R1−1 at the first maximum luminance (e.g., 10 Nits) is set to 0.7 V and the 1-2-th difference value at the second maximum luminance (e.g., 100 Nits) is set to 0.7 V. In such a case, it can be seen that the 1-3-th difference values are also set to 0.7 V for the third maximum luminances (e.g., 15 Nits, 30 Nits, 60 Nits).

The test control unit 120 may set a 1-4-th difference value for a fourth maximum luminance (e.g., 3000 Nits), and a 1-5-th difference values for a fifth maximum luminances (e.g., 200 Nits, 300 Nits, 650 Nits, 1200 Nits, and 1600 Nits), in the same manner as described above.

For example, the test control unit 120 may set a 1-4-th difference value between the first anode initialization voltage and the first power supply voltage ELVSS for the fourth maximum luminance. For example, it may be assumed that the fourth maximum luminance is 3000 Nits. The process of setting the 1-4-th difference value is the same as the process of setting the 1-1-th difference value VAR_R1−1, so it will not be described repeatedly. Referring to FIG. 15, a case where the 1-4-th difference value is set to 0.25 V is illustrated as an example.

The test control unit 120 may set a 1-5-th difference values between the first anode initialization voltage and the first power supply voltage ELVSS by interpolating the 1-2-th difference value and the 1-4-th difference value for fifth maximum luminances between the second maximum luminance and the fourth maximum luminance. For example, the fifth maximum luminances may be 200 Nits, 300 Nits, 650 Nits, 1200 Nits, and 1600 Nits. In this case, the interpolation may be performed based on a magnitude of the first power supply voltage ELVSS corresponding to the fifth maximum luminances. Referring to FIG. 15, the 1-5-th difference values are set to 0.67V, 0.64V, 0.53V, 0.31V, and 0.25V, as an example.

For example, the 1-5-th difference values may be derived by the following Equation 1. Equation 1 below may also be used to obtain the 1-3-th difference values described above.

VAR_X1=VAR_3000+{(ELVSS_X1-ELVSS_3000)*(VAR_100-VAR_3000)/(ELVSS_100-ELVSS_3000)} [Equation 1]

VAR_X1 may be a 1-5-th difference value of the fifth maximum luminance. VAR_3000 may be a 1-4-th difference value (e.g., 0.25V) of the fourth maximum luminance (e.g., 3000 Nits). ELVSS_X1 may be a first power supply voltage ELVSS of the fifth maximum luminance. ELVSS_3000 may be the first power supply voltage ELVSS of the fourth maximum luminance. VAR_100 may be a 1-2-th difference value of the second maximum luminance (e.g., 100 Nits). ELVSS_100 may be a first power supply voltage ELVSS of the second maximum luminance.

For example, the first power supply voltage ELVSS in the case where the fifth maximum luminance is 1600 Nits and the first power supply voltage ELVSS in the case where the fourth maximum luminance is 1600 Nits may be the same. Therefore, the 1-5-th difference value in the case where the fifth maximum luminance is 1600 Nits may be set to 0.25 V, as shown in FIG. 15.

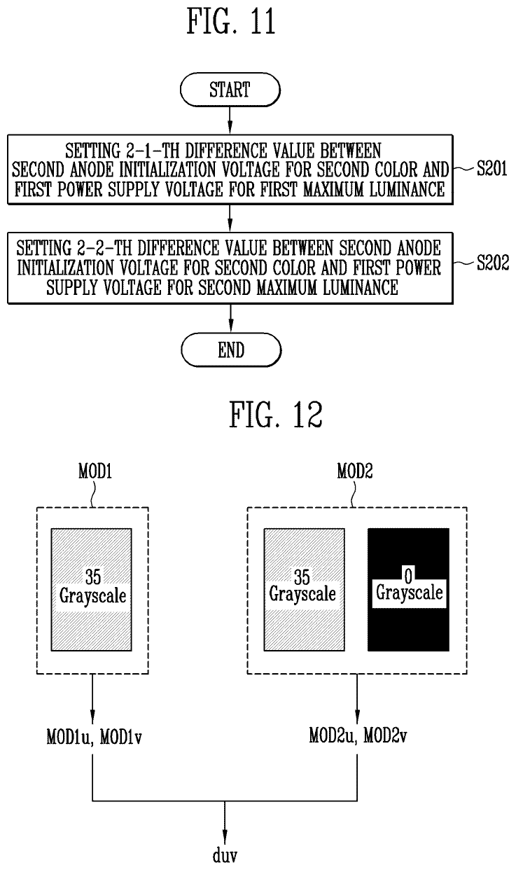

Referring to FIG. 11, operation S200 may include sub-operations S201, S202. The second difference values VAR_B may include a 2-1-th difference value VAR_B2−1, a 2-2-th difference value, and a 2-3-th difference value.

First, the test control unit 120 may set the 2-1-th difference value between the second anode initialization voltage and the first power supply voltage ELVSS for the first maximum luminance (e.g., 10 Nits) (S201).

Referring to FIG. 12, the test control unit 120 may detect a first color coordinate (MOD1u, MOD1v) of a first image (MOD1) in which the display device 10′ continuously displays a first grayscale (e.g., 35 grayscale) for the first maximum luminance. The first image MOD1 may include a plurality of consecutive frames, and each frame may be a monochromatic frame including the first grayscale.

Further, the test control unit 120 may detect, for the first maximum luminance, a second color coordinate (MOD2u, MOD2v) of the second image (MOD2) in which the display device 10′ alternately displays a first grayscale (e.g., 35 grayscale) and a black grayscale (e.g., 0 grayscale). The second image MOD2 may include a first frame and a second frame disposed temporally intersecting each other, wherein each of the first frame is a monochromatic frame composed of a first grayscale, and each of the second frame is a monochromatic frame composed of a black grayscale. Note that the second frames including black grayscale may affect luminance, but not color coordinates.

The faster the response speed of the display device 10′, the more similar the first color coordinates (MOD1u, MOD1v) and the second color coordinates (MOD2u, MOD2v) may become. Accordingly, the test control unit 120 may set a difference value in which the difference duv between the first color coordinate (MOD1u, MOD1v) and the second color coordinate (MOD2 u, MOD2 v) is minimum as a 2-1-th difference value VAR_B2−1. For example, referring to FIG. 13, a graph of the color coordinate difference duv according to a difference value between the second anode initialization voltage and the first power supply voltage ELVSS is shown.

For example, the color coordinate difference duv may be calculated or be based on a calculation as shown in the following Equation 2.

duv=\sqrt{(MOD1u−MOD2u)²+(MOD1v−MOD2v)²} [Equation 2]

Where duv is the color coordinate difference duv, MOD1u may be the u color coordinate of the Luv color space in the first image (MOD1), MOD2u may be the u color coordinate of the Luv color space in the second image (MOD2), MOD1v may be the v color coordinate of the Luv color space in the first image (MOD1), and MOD2v may be the v color coordinate of the Luv color space in the second image (MOD2). In some example embodiments, coordinates of other color spaces may be used to calculate the color coordinate difference. For example, referring to FIG. 15, the 2-1-th difference value may be set to 1.65V.

Next, the test control unit 120 may set, for the second maximum luminance (e.g., 100 Nits), a 2-2-th difference value between the second anode initialization voltage and the first power supply voltage ELVSS (S202). At this time, the test control unit 120 may detect, for the second maximum luminance, a third color coordinate of the third image in which the display device 10′ continuously displays the first grayscale. Next, the test control unit 120 may detect, for the second maximum luminance, a fourth color coordinate of the fourth image in which the display device 10′ displays the first grayscale and the black grayscale alternately. The test control unit 120 may set a difference value that is the minimum difference or that is based on the minimum difference between the third color coordinate and the fourth color coordinate as the 2-2 difference value. For example, referring to FIG. 15, the 2-2-th difference value may be set to 1.55V. This process is substantially the same as setting the 2-1-th difference value VAR_B2−1, so redundant descriptions are omitted.

Similarly, the test control unit 120 may set a 2-4-th difference value between the second anode initialization voltage and the first power supply voltage ELVSS for a fourth maximum luminance (e.g., 3000 Nits), in the same manner as described above. For example, referring to FIG. 15, the 2-4-th difference value may be set to 1.10V. This process is substantially the same as setting the 2-1-th difference value VAR_B2−1, so redundant description is omitted.

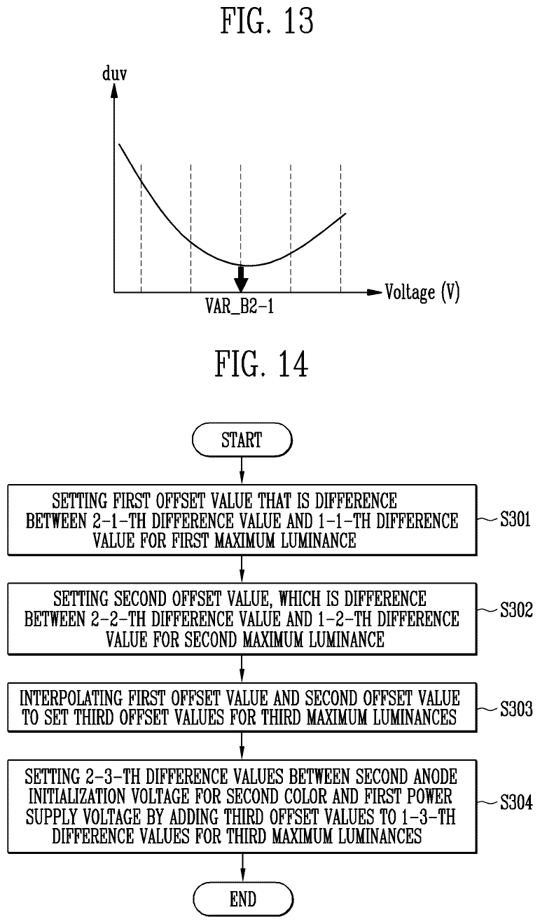

Referring to FIG. 14, operation S300-1 may include detail operations S301, S302. The operation S300-2 may include a detail operation S303. The operation S300-3 may include the detail operation S304.

The test control unit 120 may set a first offset value that is a difference between the 2-1-th difference value (VAR_B2−1) and the 1-1-th difference value (VAR_R1−1) for a first maximum luminance (e.g., 10 Nits) (S301). For example, the first offset value may be the 2-1-th difference value (VAR_B2−1) minus the 1-1-th difference value VAR_R1−1. For example, referring to FIG. 15, the first offset value may be set to 0.95 volts. Further, the test control unit 120 may set a second offset value, which is a difference between the 2-2-th difference value and the 1-2-th difference value, for a second maximum luminance (e.g., 100 Nits) (S302). For example, referring to FIG. 15, the second offset value may be set to 0.85 volts. Similarly, for a fourth maximum luminance (e.g., 3000 Nits), the test control unit 120 may set a fourth offset value that is a difference between the 2-4-th difference value and the 1-4-th difference value. For example, referring to FIG. 15, the fourth offset value may be set to 0.85 volts.

The test control unit 120 may interpolate the first offset value and the second offset value for the third maximum luminances (e.g., 15 Nits, 30 Nits, 60 Nits) to set third offset values (S303). In this case, the interpolation may be performed based on a magnitude of a maximum luminance DBV corresponding to the third maximum luminances. Referring to FIG. 15, the third offset values are set to 0.94 V, 0.93 V, and 0.90 V, respectively, as an example. For example, the third offset values may be derived by the following Equation 3.

OFFSET_X1=OFFSET_100+{(DBV_X1-DBV_100)*(OFFSET_10-OFFSET_100)/(DBV_10-DBV_100)} [Equation 3]

OFFSET_X1 may be a third offset value of the third maximum luminance. OFFSET_100 may be a second offset value (e.g., 0.85 V) of the second maximum luminance (e.g., 100 Nits). DBV_X1 may be a luminance value of the third maximum luminance. DBV_100 may be a luminance value (e.g., 100 Nits) of the second maximum luminance. OFFSET_10 may be a first offset value (e.g., 0.95 V) of the first maximum luminance (e.g., 10 Nits). DBV_10 may be a luminance value of the first maximum luminance (e.g., 10 Nits).

Similarly, the test control unit 120 may set the fifth offset values by interpolating the second offset value and the fourth offset value for the fifth maximum luminances (e.g., 200 Nits, 300 Nits, 650 Nits, 1200 Nits, and 1600 Nits). This process is substantially the same as the process for obtaining the third offset values and will not be redundantly described. However, in the case of FIG. 15, since the second offset value and the fourth offset value are each equal to 0.85 V, the fifth offset values may all be set to 0.85 V.

For the third maximum luminances, the test control unit 120 may set 2-3-th difference values between the second anode initialization voltage and the first power supply voltage ELVSS by adding third offset values to the 1-3-th difference values (S304). Similarly, for the fifth maximum luminances, the test control unit 120 may set 2-3-th difference values between the second anode initialization voltage and the first power supply voltage ELVSS by adding fifth offset values to the 1-5-th difference values (S304).

Referring to FIG. 15, the first difference values VAR_R set via operations S101 to S103, the 2-1-th, 2-2-th, and 2-4-th difference values VAR_B set via operations S201 to S202, the offset values OFFSET set via operations S301 to S303, and remaining second difference values VAR_B set via operation S304 are illustrated as an example.

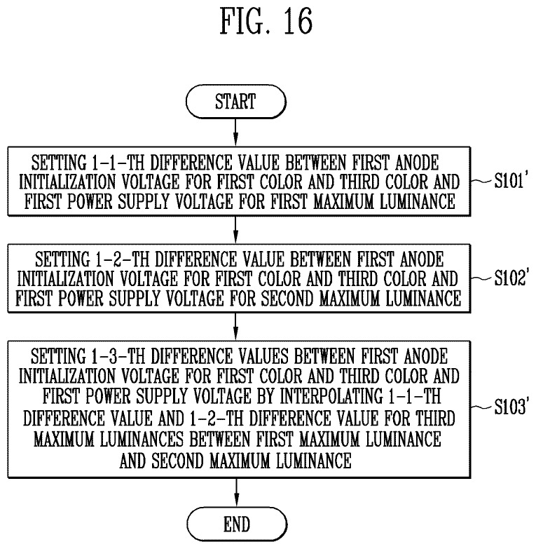

FIGS. 16 to 18 are drawings for illustrating a voltage setting method of a display device according to another embodiment of the present invention.

Referring to FIG. 16, each of the operations S101′, S102′, and S103′ differs from the operations S101, S102, and S103 of FIG. 9 in that they set a 1-1-th difference value, a 1-2-th difference value, and a 1-3-th difference value not only for the first color (e.g., red), but also for the third color (e.g., green). For example, in some example embodiments, the first anode initialization voltage for the first color and the third anode initialization voltage for the third color may be the same.

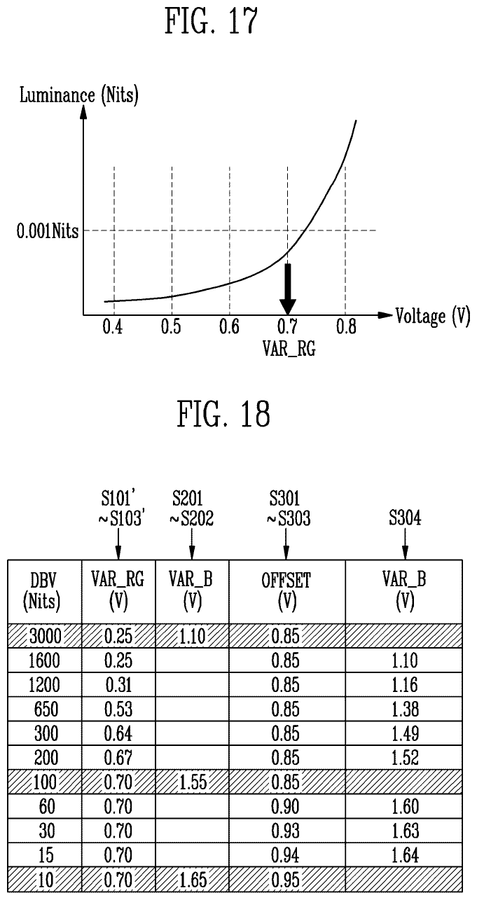

Referring to FIG. 17, a graph of luminance according to a difference value VAR_RG between an anode initialization voltage and a first power supply voltage ELVSS for the first and third colors is shown when the display device 10′ displays a black image of a black grayscale. In this case, the difference value for the second color may be set as the difference value VAR_RG plus an offset (such as a predetermined or dynamically determined offset).

Referring now to FIG. 18, an embodiment of the difference values VAR_RG set via operations S101′ through S103′, the 2-1-th, 2-2-th, and 2-4-th difference values VAR_B set via operations S201 through S202, the offset values OFFSET set via operations S301 through S303, and the remaining second difference values VAR_B set via operation S304 is shown.

In the description of FIGS. 16 through 18, descriptions that are redundant with the descriptions of FIGS. 8 through 15 are omitted.

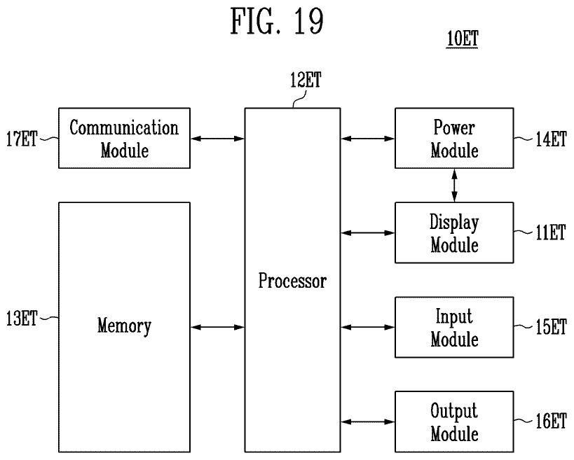

FIG. 19 is a block diagram of an electronic device according to some example embodiments. Referring to FIG. 19, the electronic device 10ET according to one embodiment may include a display module 11ET, a processor 12ET, a memory 13ET, and a power module 14ET. The display module 11ET may be represented as a display device.

The processor 12ET may include at least one of a central processing unit (CPU), an application processor (AP), a graphic processing unit (GPU), a communication processor (CP), an image signal processor (ISP), and a controller. In some example embodiments, the processor 12ET may be partitioned into two or more from a functional or structural perspective. For example, the processor 12ET may include a main processor in the form of a first drive chip that includes a central processing unit, and a second processor in the form of a second drive chip that includes a controller that receives image signals from the main processor and processes the image signals to meet the interface specifications of the display device 11ET. The processor 12ET may provide image data. The display module 11ET may display an image based on grayscales of the image data.

The memory 13ET may include at least one of a non-volatile memory and a volatile memory. The memory 13ET may store data information necessary for or used during operation of the processor 12ET or the display module 11ET. When the processor 12ET executes an application stored in the memory 13ET, image data signals and/or input control signals may be delivered to the display module 11ET, and the display module 11ET may process the received signals to output image information via the display screen.

The power module 14ET can include a power supply module, such as a power adapter or battery unit, and a power conversion module that converts the power supplied by the power supply module to generate the power required for operation of the electronic device 10ET. The power conversion by the power conversion module may include, but is not limited to, DC-DC conversion, AC-DC conversion, and DC-AC conversion.

The electronic device 10ET may further include an input module 15ET, a non-image output module 16ET, and/or a communication module 17ET.

The input module 15ET can provide input information to the processor 12ET and/or the display module 11ET. The input module 15ET can include physical buttons, a keyboard, a microphone, as well as various sensor modules. Examples of sensor modules may include one or more of touch sensors, pressure sensors, distance sensors, position sensors, digitizers, motion recognition sensors, camera sensors, light sensors, photoelectric sensors, temperature sensors, as well as biosensors such as blood pressure sensors, blood glucose sensors, electrocardiogram sensors, heart rate sensors, and the like.

The non-image output module 16ET may serve to receive information other than images received from the processor 12ET and provide it to a user. Examples of the non-image output module 16ET include an acoustic module, a haptic module, a light emitting module, and the like, and may include other functional modules unique to the electronic device (e.g., a cooling module of a refrigerator, etc.).

The communication module 17ET is a module responsible for sending and receiving information between the electronic device 10ET and an external device, and may include a receiving part and a transmitting part. The communication module 17ET may include various wireless communication modules, such as one or more of a mobile communication module, a Wi-Fi module, a Bluetooth module, or various wired communication modules.

At least one of each of the above-described configurations of the electronic device 10ET may be included within a display device according to the above-described example embodiments. Furthermore, some of the individual modules that are functionally included within one module may be included within the display device and others may be provided separately from the display device. For example, the display device may include a display module 11ET, while the processor 12ET, memory 13ET, and power module 14ET may be provided in the form of other devices within the electronic device 10ET other than the display device. As another example, the power module 14ET may be arranged within the display device and provide power to the processor 12ET and memory 13ET provided within the electronic device 10ET that is not the display device, and is not limited to the above examples.

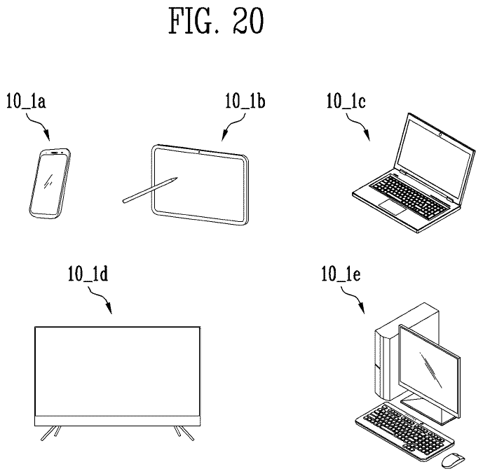

FIGS. 20 through 22 are schematic diagrams of electronic devices according to various example embodiments. FIGS. 20 through 22 illustrate examples of various electronic devices with display devices according to various embodiments.

FIG. 20 illustrates a smartphone 10_1a, a tablet PC 10_1b, a laptop 10_1c, a TV 10_1d, and a desk monitor 10_1e as examples of electronic devices.

In addition to the display module 11ET, the smartphone 10_1a may include an input module, such as a touch sensor, and a communication module. The smartphone 10_1a may process information received via the communication module or other input module and display the information via the display module of the display device.

Similar to the smartphone 10_1a, tablet PCs 10_1b, laptops 10_1c, TVs 10_1d, and desk monitors 10_1e also include a display module and an input module, and in some cases may further include a communication module.

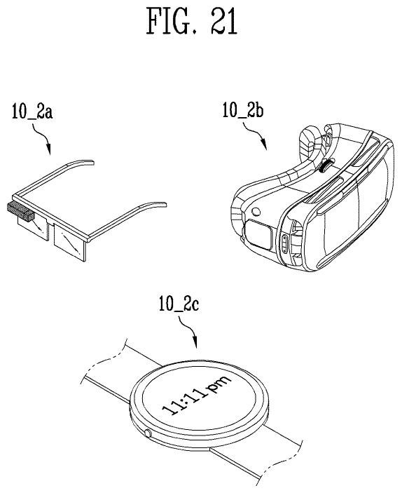

FIG. 21 illustrates a case in which an electronic device including a display module is applied to a wearable electronic device. The wearable electronic device may be a smart glasses 10_2a, a head-mounted display 10_2b, a smart watch 10_2c, or the like.

The smart glasses 10_2a and the head-mounted display 10_2b may include a display module for projecting a display image, and a reflector for reflecting the projected display image and providing it to the user's eyes, thereby providing a screen of virtual reality or augmented reality to the user.

The smartwatch 10_2c may include a biometric sensor as an input device, and may provide biometric information recognized through the biometric sensor to the user via the display module.

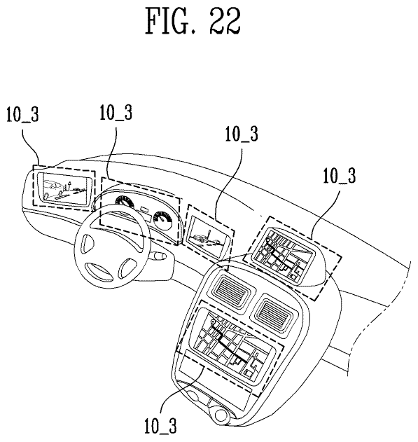

FIG. 22 illustrates a case where an electronic device including a display module is applied to an automobile. For example, the electronic device 10_3 may be applied to an instrument panel, center fascia, or the like of a vehicle, or to a center information display (CID) arranged on the dashboard of a vehicle, or to a room mirror display that replaces a side mirror, or the like.

The voltage setting method and voltage setting device of the display device according to some example embodiments may enable the display device to display an image with a targeted luminance and color coordinates.

The foregoing referenced drawings and detailed description of the invention are examples only and are intended to illustrate inventive concepts and are not intended to limit the meaning or to limit the scope of inventive concepts as claimed in the appended patent claims. Accordingly, one having ordinary skill in the art will understand that various modifications and other equally valid embodiments are possible therefrom. Accordingly, the true scope of technical protection of inventive concepts is to be determined by the technical ideas of the appended patent claims. Additionally, example embodiments are not necessarily mutually exclusive with one another. For example, some example embodiments may include one or more features described with reference to one or more figures, and may also include one or more other features described with reference to one or more other figures.

What is claimed is:

1. A voltage setting method of a display device comprising:
for a plurality of luminances, setting first difference values between a first anode initialization voltage for a first color and a first power supply voltage;
for some luminances of the plurality of luminances, setting second difference values between a second anode initialization voltage for a second color and the first power supply voltage;
for the some luminances, setting offset values that are differences between the second difference values and the first difference values;
based on the offset values for the some luminances, setting remaining offset values for remaining luminances; and
for the remaining luminances, setting remaining difference values for the second color, based on the remaining offset values and the first difference values.

2. The voltage setting method of claim 1,
wherein the setting the first difference values comprises:
for a first luminance, setting a 1-1-th difference value between the first anode initialization voltage and the first power supply voltage;
for a second luminance, setting a 1-2-th difference value between the first anode initialization voltage and the first power supply voltage; and
for third luminances between the first luminance and the second luminance, interpolating the 1-1-th difference value and the 1-2-th difference value to set 1-3-th difference values between the first anode initialization voltage and the first power supply voltage.

3. The voltage setting method of claim 2,
wherein, in the setting the 1-1-th difference value,
for the first luminance, the 1-1-th difference value is set based on a maximum value among difference values that set a luminance of a black image of the display device being lower than a reference luminance.

4. The voltage setting method of claim 3,
wherein, in the setting the 1-2-th difference value,
for the second luminance, the 1-2-th difference value is set based on a maximum value among difference values that set the luminance of the black image of the display device being lower than the reference luminance

5. The voltage setting method of claim 2,
wherein the setting the second difference values comprises:
for the first luminance, setting a 2-1-th difference value between the second anode initialization voltage and the first power supply voltage; and
for the second luminance, setting a 2-2-th difference value between the second anode initialization voltage and the first power supply voltage.

6. The voltage setting method of claim 5,
wherein the setting the 2-1-th difference value comprises:
for the first luminance, detecting a first color coordinate of a first image in which a first grayscale is continuously displayed by the display device;
for the first luminance, detecting a second color coordinate of a second image in which the first grayscale and black grayscale are alternately displayed by the display device; and
setting the 2-1-th difference value based on a difference value in a case that a difference between the first color coordinate and the second color coordinate is minimum.

7. The voltage setting method of claim 6,
wherein the setting the 2-2-th difference value comprises:
for the second luminance, detecting a third color coordinate of a third image in which the first grayscale is continuously displayed by the display device;
for the second luminance, wherein detecting a fourth color coordinate of a fourth image in which the first grayscale and the black grayscale are alternately displayed by the display device; and
setting the 2-2-th difference value based on a difference value in a case that a difference between the third color coordinate and the fourth color coordinate is minimum.

8. The voltage setting method of claim 5,
wherein the setting the offset values comprises:
for the first luminance, setting a first offset value that is a difference between the 2-1-th difference value and the 1-1-th difference value; and
for the second luminance, setting a second offset value that is a difference between the 2-2-th difference value and the 1-2-th difference value.

9. The voltage setting method of claim 8,
wherein the setting the remaining offset values comprises:
for the third luminances, interpolating the first offset value and the second offset value to set third offset values.

10. The voltage setting method of claim 9,
wherein the setting the remaining difference values comprises:
for the third luminances, setting 2-3-th difference values between the second anode initialization voltage and the first power supply voltage by adding the third offset values to the 1-3-th difference values.

11. A voltage setting device comprising:
a test control unit configured to provide test voltages to a display device to enable the display device to display an image; and
an optical system configured to measure luminance of and color coordinates of the image,
wherein the test control unit
is configured to set first difference values between a first anode initialization voltage for a first color and a first power supply voltage for a plurality of luminances,
is configured to set second difference values between a second anode initialization voltage for a second color and the first power supply voltage for some luminances of the plurality of luminances,
is configured to set offset values that are difference between the second difference values and the first difference values for the some luminances,
based on the offset values for the some luminances, is configured to set remaining offset values for remaining luminances, and
is configured to set remaining difference values for the second color, based on the remaining offset values and the first difference values for the remaining luminances.

12. The voltage setting device of claim 11,
wherein, in setting the first difference values, the test control unit, the test control unit is configured to
set a 1-1-th difference value between the first anode initialization voltage and the first power supply voltage for a first luminance,
set a 1-2-th difference value between the first anode initialization voltage and the first power supply voltage for a second luminance, and
interpolate the 1-1-th difference value and the 1-2-th difference value to set 1-3-th difference values between the first anode initialization voltage and the first power supply voltage for third luminances between the first luminance and the second luminance.

13. The voltage setting device of claim 12,
wherein, in setting the 1-1-th difference value, the test control unit is configured to
set a maximum value among difference values that set a luminance of a black image of the display device to be lower than a reference luminance as the 1-1-th difference value for the first luminance.

14. The voltage setting device of claim 13,
wherein, in setting the 1-2-th difference value, the test control unit is configured to,
set a maximum value among difference values that set the luminance of the black image of the display device to be lower than the reference luminance as the 1-2-th difference value for the second luminance.

15. The voltage setting device of claim 12,
wherein, when setting the second difference values the test control unit is configured to,
set a 2-1-th difference value between the second anode initialization voltage and the first power supply voltage for the first luminance, and
set a 2-2-th difference value between the second anode initialization voltage and the first power supply voltage for the second luminance.

16. The voltage setting device of claim 15,
wherein, in setting the 2-1-th difference value, the test control unit is configured to,
detect a first color coordinate of a first image in which a first grayscale is continuously displayed by the display device for the first luminance,
detect a second color coordinate of a second image in which the first grayscale and black grayscale are alternately displayed by the display device for the first luminance, and
set a difference value in a case that difference between the first color coordinate and the second color coordinate is minimum as the 2-1-th difference value.

17. The voltage setting device of claim 16,
wherein, in setting the 2-2-th difference value, the test control unit is configured to,
detect a third color coordinate of a third image in which the first grayscale is continuously displayed by the display device for the second luminance,
detect a fourth color coordinate of a fourth image in which the first grayscale and the black grayscale are alternately displayed by the display device for the second luminance, and set a difference value in a case that a difference between the third color coordinate and the fourth color coordinate is minimum as the 2-2-th difference value.

18. The voltage setting device of claim 15,
wherein, in setting the offset values, the test control unit is configured to
set a first offset value that is a difference between the 2-1-th difference value and the 1-1-th difference value for the first luminance, and
set a second offset value that is a difference between the 2-2-th difference value and the 1-2-th difference value for the second luminance.

19. The voltage setting device of claim 18,
wherein, when in setting the remaining offset values, the test control unit is configured to,
interpolate the first offset value and the second offset value to set third offset values for the third luminances.

20. The voltage setting device of claim 19,
wherein, in setting the remaining difference values, the test control unit is configured to,
set 2-3-th difference values between the second anode initialization voltage and the first power supply voltage by adding the third offset values to the 1-3-th difference values for the third luminances.
